(19) United States
(12) Patent Application Publication
(10) Pub. No.: US 2005/0052981 A1
(43) Pub. Date: Mar. 10, 2005

(54) Record controlled sound playback device

(76) Inventors: Brian Shim, Santa Monica, CA (US); Christopher Roman, Wrentham, MA (US)

Correspondence Address: BARLOW, JOSEPHS & HOLMES, LTD., 101 DYER STREET, 5TH FLOOR, PROVIDENCE, RI, 02903, US

(21) Appl. No.: 10/935,492

(22) Filed: Sep. 7, 2004

Related U.S. Application Data
(60) Provisional application No. 60/501,487, filed on Sep. 9, 2003.

(51) Int. Cl. G11B 5/09

(52) U.S. Cl. 369/59.26; 369/47.38

(57) ABSTRACT

The digital sound playback device (10) of the present invention includes a physical interface that closely simulates an analog scratch turntable. The digital sound playback device (10) includes a motor (30) that directly drives a hollow spindle (36). A platter (14) is connected to the hollow spindle (36). A center spindle (18) is routed through the hollow spindle (36) where the rotational axis of the hollow spindle (36) is co-axial with the rotational axis of the center spindle (18). A full-size vinyl LP record (16) is removably connected to the center spindle (18). Digital encoders (82, 84) are used to respectively detect the rotational speed and direction of the platter (14) and the center spindle (18) to respectively create a platter and center spindle control signal. The control signals are used by a central control processor (100) to determine how the digitized audio should be modified. As a result, a digital audio file can be scratched in similar fashion to an analog vinyl record on an analog turntable.

### CROSS REFERENCE TO RELATED APPLICATION

This application is related to and claims priority from earlier filed provisional patent application Ser. No. 60/501,487, filed Sep. 9, 2003.

### BACKGROUND OF THE INVENTION

The invention relates generally to the playback and manipulation of audio. The present invention particularly relates to audio players that can manipulate audio in real time to provide different types of sound effects.

Turntables are well known in the prior art for use in the playback of audio, such as music, which are located on vinyl records. Details of the operation of an analog turntable is so well known, that details of the operation thereof need not be discussed herein. By way of background, these prior art turntables include a rotating platter that is driven by a motor either directly or via belts. A spindle is positioned at the axis of platter. A record, having a center hole, is positioned on the platter with the platter spindle routed through the hole. As a result, the vinyl record remains centered on the platter for rotation therewith.

A tone arm is provided with cartridge on the free end thereof. A needle in the cartridge communicates with grooves located on the vinyl surface of the record. It is well known that passage of the needle through the grooves of the vinyl record creates analog sound waves that are, in turn, electronically communicated through the tone arm for broadcast through a sound system. Typically, the record is played back in a forward direction and at its specified speed, such as 33⅓ rotations per minute. Such “normal” playback results in the recorded audio to played back as originally desired by the creator of the vinyl record.

However, it is possible that the playback of these prior art analog vinyl records can be manipulated to create unique sound effects. For example, the record can be sped up or slowed down or moved back and forth while the needle remains within the grooves of the vinyl record. This technique of manually altering the playback of vinyl records is known as the musical art form of “scratching” and can be done to any vinyl record, such as a recording of currently popular music.

In the industry of vinyl record scratching, special equipment has been designed over the years to accommodate this particular style of interactive playback of vinyl records. For example, specialized needles and turntables, with drive systems that are designed for constant back and forth movement of the platter, have been created. Also, slip mats are typically positioned between the vinyl record and the motor-driven platter to facilitate rotation of the record independently of the turntable platter. Different slip mats can be employed with differing levels of friction to suit the needs of the user of the scratch turntable. In view of the foregoing, the key to effective scratching is the physical interaction of the user with the record and the turntable and needle.

The use of the scratching technique of sound playback using vinyl records has become very popular. However, the sale and popularity of analog vinyl records has significantly dropped over the years as the preferred medium for recording audio, such as music. Instead, the medium of choice is digital audio for the sound quality, ease of storage and playback. For example, digital audio is commonly stored as a digital file. It can be stored on any type of digital storage media, such as optical compact audio discs and magnetic discs, such as hard drives or compact flash media. As a result, turntables are not used to playback music. Instead, digital compact disc players, computers and digital portable media players are now employed for playback.

While digital music has important advantages over analog vinyl records, there is a significant drawback in that digital audio cannot be scratched because digital audio is not played back on a record turntable like analog music. Thus, there has become a desire to simulate the scratching of digital audio to obtain similar results as scratching analog audio found on vinyl records.

There have been many attempts in the prior art to perform a scratch effect on a digital audio file. In the prior art, a digital audio file is typically loaded into a memory buffer from a compact disc or other storage medium. A rotating disc is typically employed with a sensor connected thereto to measure the speed and direction of the disc. Data concerning the rotation speed and direction of the disc is received by a digital microprocessor for digital signal processing according to a desired algorithm and system software. For example, if data is received by the microprocessor that the disc is being slowed down to half speed, then the microprocessor will cause the output signal to be slowed down accordingly to match the speed of the controller disc. Similarly, if the controller disc is rotated backwards, the microprocessor will process the digital audio and output it as reversed audio. Details of digital signal processing by a controller disc is well known in the art and need not be discussed in further detail herein.

In general, digital signal processing of digital audio to achieve scratching sound effects is quite realistic and suitable for performance by disc jockeys and the like. However, such scratch performers also require a physical interface that is as close as possible, both in look, feel and operation, to an analog turntable to provide as close as possible of a scratching performance. Most importantly, the physical interface for digital scratching will result in a scratch performance that most closely simulates an analog scratch performance.

The physical interface of prior art digital scratching devices do not closely simulate an analog turntable which disc jockeys and other performers are used to. The controller discs of the prior art are typically small circular platters that are merely provided to only generally simulate an actual vinyl record found in a real analog turntable. As a result, the general feel and action of these prior art digital scratching devices are not particularly close to a real analog turntable.

However, there have been attempts in the prior to close simulate an analog scratch turntable with a digital device. For example, efforts have been made in the prior art to provide a separate “record” and platter which both have their own detectors connected thereto for monitoring of speed and directional. The “record” in these prior art devices is a custom vinyl or plastic disc that is connected to the spindle of the device. For example, these “records” have a special keyed center hole that engages with a specially configured turntable spindle. Also, the size of the disc is typically smaller than a normal LP disc. This custom disc must be used with the digital scratch turntables of the prior art.

In view of the foregoing, there is a demand for a device that can closely simulate analog scratching of vinyl records not only from a sound output standpoint but also from a physical interface standpoint. There is a particular demand for a digital scratch turntable to virtually indistinguishable from an analog turntable. There is a demand for the interface “record” to be as close as possible to a real vinyl record. There is a demand for such a digital scratch turntable to include a platter that is identical to platters found in analog turntables. There is a further demand for a digital scratch turntable to use a slip mat to more closely simulate analog scratch action. Also, there is a demand for a digital scratch turntable to have the feel of an analog turntable to improve the overall scratch performance and enjoyment of the performer.

### SUMMARY OF THE INVENTION

The present invention preserves the advantages of prior art digital scratch turntables. In addition, it provides new advantages not found in currently available turntables and overcomes many disadvantages of such currently available turntables.

The invention is generally directed to the novel and unique digital scratch turntable. The turntable of the present invention has particular use in the disc jockey music industry in that the turntable can be used to simulate a scratch performance using digital audio instead of an analog turntable using an analog vinyl record.

The digital turntable of the present invention more closely simulates analog scratching that any prior art playback device. The present invention addresses the foregoing problems associated with the prior art while providing superior performance and reliability.

The digital sound playback device of the present invention includes a physical interface that closely simulates an analog scratch turntable. The digital sound playback device includes a motor that directly drives a hollow spindle. A center spindle is routed through the hollow spindle where the rotational axis of the hollow spindle is co-axial with the rotational axis of the center spindle. A full-size vinyl LP record is removably connected to the center spindle. Digital encoders are used to respectively detect the rotational speed and direction of the platter and the center spindle to respectively create a platter and center spindle control signal. The control signals are used by a central control processor to determine how the digitized audio should be modified. As a result, a digital audio file can be scratched in similar fashion to an analog vinyl record on an analog turntable.

It is therefore an object of the present invention to provide a digital sound playback device that can digitally scratch a digital audio file.

It is an object of the present invention to provide a digital sound playback device that closely simulates the physical interface of an analog turntable.

It is a further object of the present invention to provide a digital sound playback device that uses a full-size vinyl LP to simulate scratching.

Another object of the present invention is to provide a digital sound playback device that has a feel and operation that is identical to an analog scratch turntable.

### BRIEF DESCRIPTION OF THE DRAWINGS

The novel features which are characteristic of the present invention are set forth in the appended claims. However, the invention's preferred embodiments, together with further objects and attendant advantages, will be best understood by reference to the following detailed description taken in connection with the accompanying drawings in which:

FIG. 1 is a front perspective view of the digital playback device of the present invention;

FIG. 2 is an front exploded perspective view of the platter and vinyl record assembly of the present invention;

FIG. 3 is a top perspective view of the turntable platter of the player of FIG. 1;

FIG. 4 is a top perspective view of the turntable platter of FIG. 3 with scratch slip mat residing thereon;

FIG. 5 is a close up view of a vinyl record mounted on the center spindle of the present invention;

FIG. 6 is a top view of the locking cap position on the vinyl record to secure the vinyl record to the center spindle;

FIG. 7 is a bottom view of the locking cap of FIG. 6;

FIG. 8 is a side elevational view of the motor assembly of the present invention mounted under the support housing;

FIG. 9 is a close up side elevational view of the motor assembly of FIG. 8;

FIG. 10 is a cross-sectional view through the line 10-10 of FIG. 1;

FIG. 11 is a top perspective view of the motor housing emanating upwardly through the support housing;

FIG. 12 is a bottom perspective view of the turntable platter;

FIG. 13 is a close up side elevational view of the motor assembly showing the digital encoder for the center spindle;

FIG. 14 is a close up side elevational view of the motor assembly showing the digital encoder for the turntable platter; and

FIG. 15 is a close up view of an encode wheel and an optical detector.

### DETAILED DESCRIPTION OF THE PREFERRED EMBODIMENT

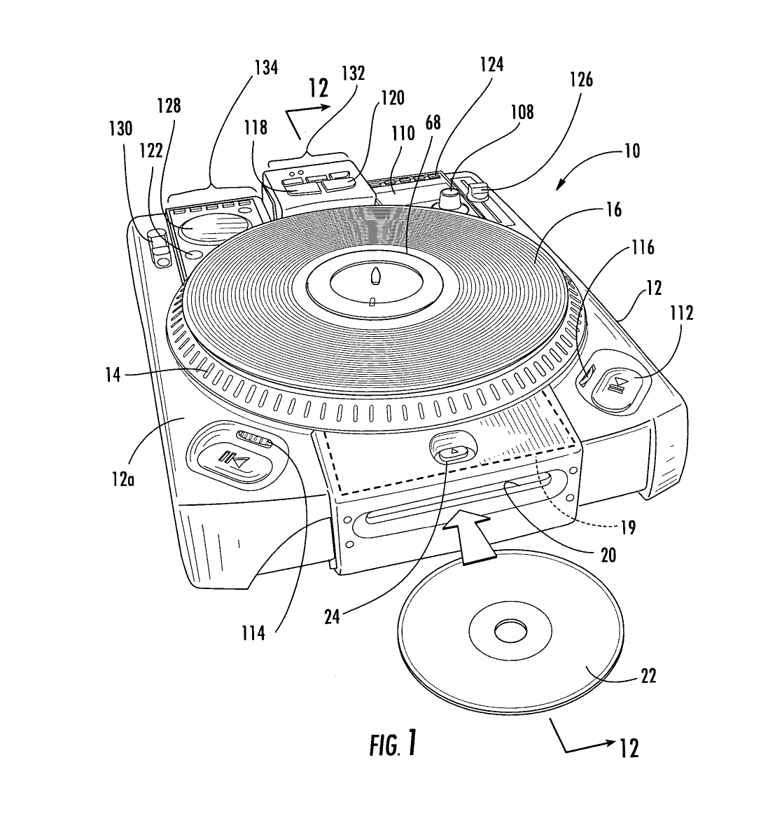

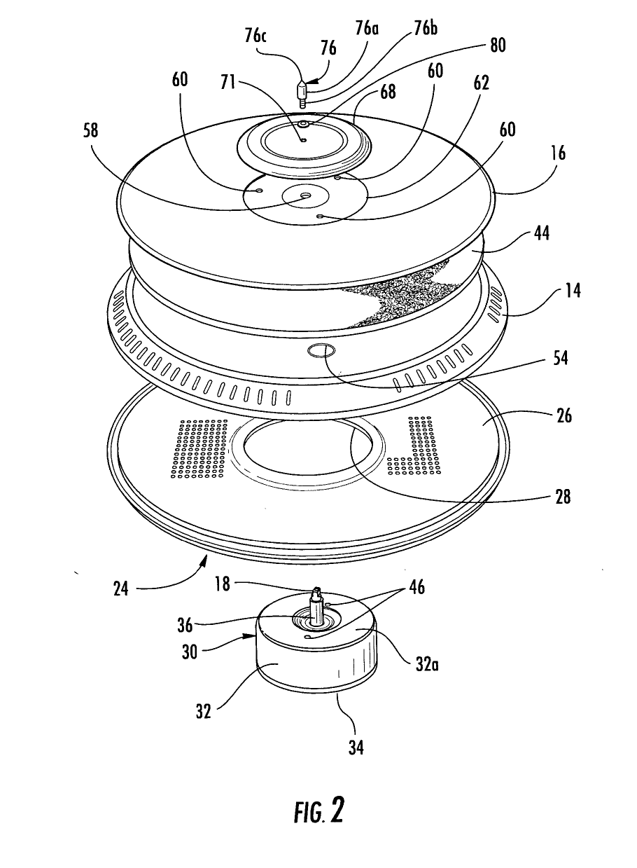

Referring first to FIG. 1, a perspective view of the record controlled playback device 10 of the present invention is shown. The device 10 is audio playback machine that, in general, reads a digital audio file from storage and places it into memory for later custom, on-the-fly manipulation by the user to modify the playback thereof for added enjoyment of the audio itself.

The audio file can be retrieved from any storage medium, such as compact disc (“CD”) or hard drive. For ease of discussion and illustration, the present invention is shown and described in detail in connection with retrieving a digital audio file from a CD, however, it should be understood that the present invention can be used to retrieve a digital audio file for later manipulation from any storage medium, such as a hard drive or removable media, such as flash memory cards. The scope of the present invention is intended to cover any type of the foregoing storage mediums.

The playback device 10 is an electrical device that is driven by a power source, such as AC power, using a wall outlet, and the like. As will be described below, various electronic components are employed in the device of the present invention. The nature and type of the power supply can be modified to suit the components employed in the playback device.

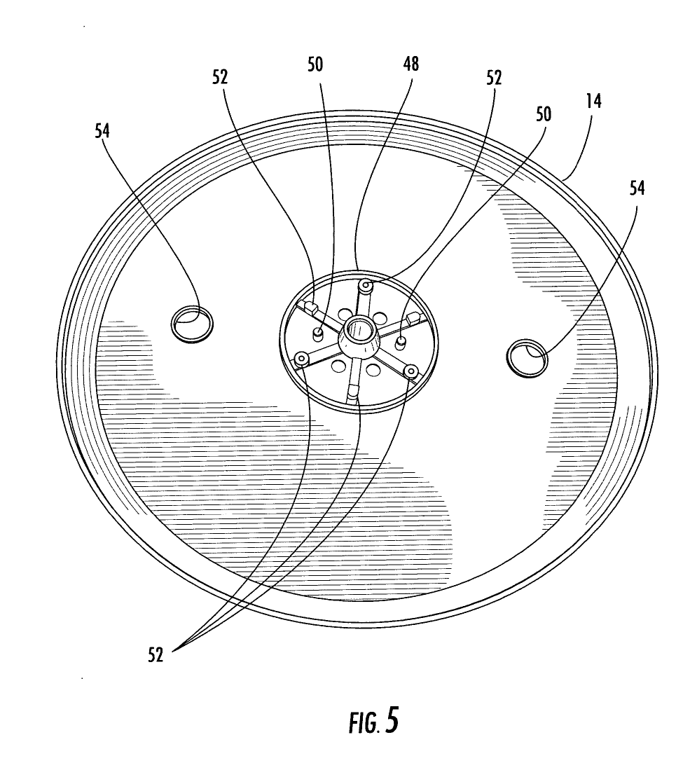

Still referring to FIG. 1, the playback device 10 of the present invention includes an outer main housing 12 with a turntable platter 14 rotatably mounted thereon. A user control disc 16, preferably an actual vinyl record, is removably connected to a center spindle 18, as seen in FIGS. 2 and 4. For example, a user's favorite vinyl record with a decorative central label portion can be used as the circular disc 16. As will be described in detail below, the speed and direction of platter 14 and the circular disc 16 are independently monitored so that control signals are generate to modification of an audio signal.

The playback device 10 also includes a number of user controls positioned about the top surface 12a of the main housing 12 of device 10. The nature and layout of the user controls is preferably provided to best suit the needs of a disc jockey. Most importantly, the user controls are provided that provide a playback device that simulates an analog scratch turntable as closely as possible. As can be seen, the appearance of the playback device 10 is virtually identical to a standard analog scratch turntable except that the present invention does not include a tone arm or a needle cartridge.

The playback device 10 of the present invention includes a build-in optical reader 19, namely, otherwise known as a compact disc drive. A front loading slot 20 is located in the front of the device for receiving a compact disc 22. The compact disc player 19 optically reads the digital audio data on the optical disc 22 and outputs digital audio waveform data. Compact disc players 19 are well known in the art and need not be discussed in further detail herein. An eject button 24 is employed for ejecting the compact disc 22 when further use of that disc is no longer needed. Various buttons are provided for complete control of the playback of the selected audio signal. Further details of the user controls will be discussed below in connection with the operation and use of the playback device of the present invention.

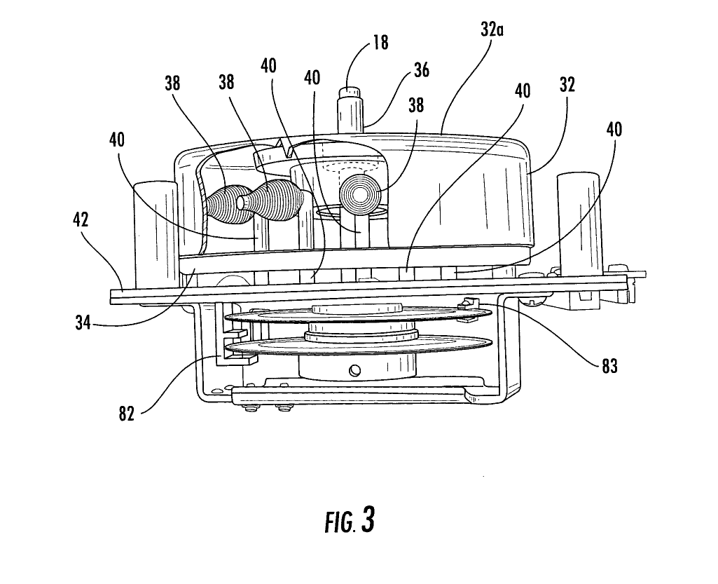

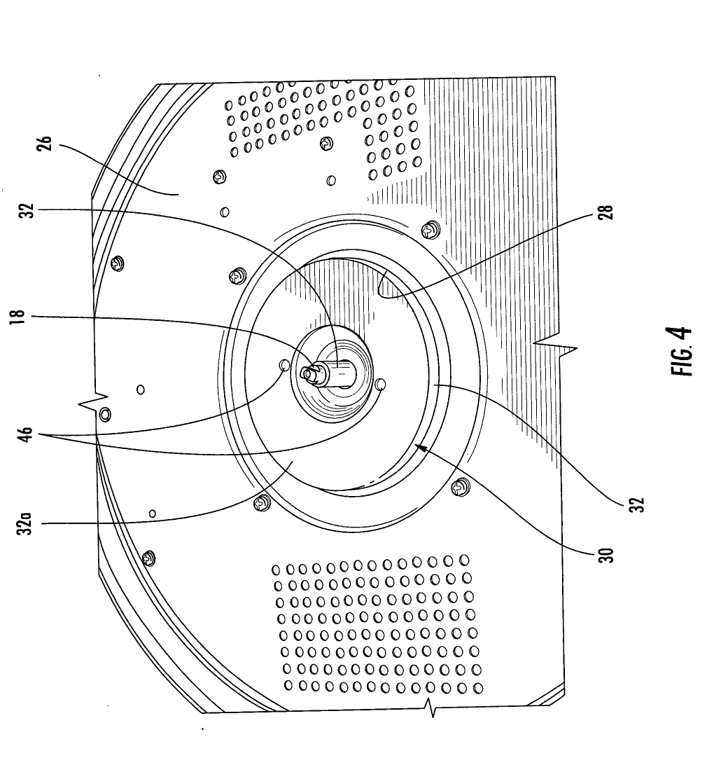

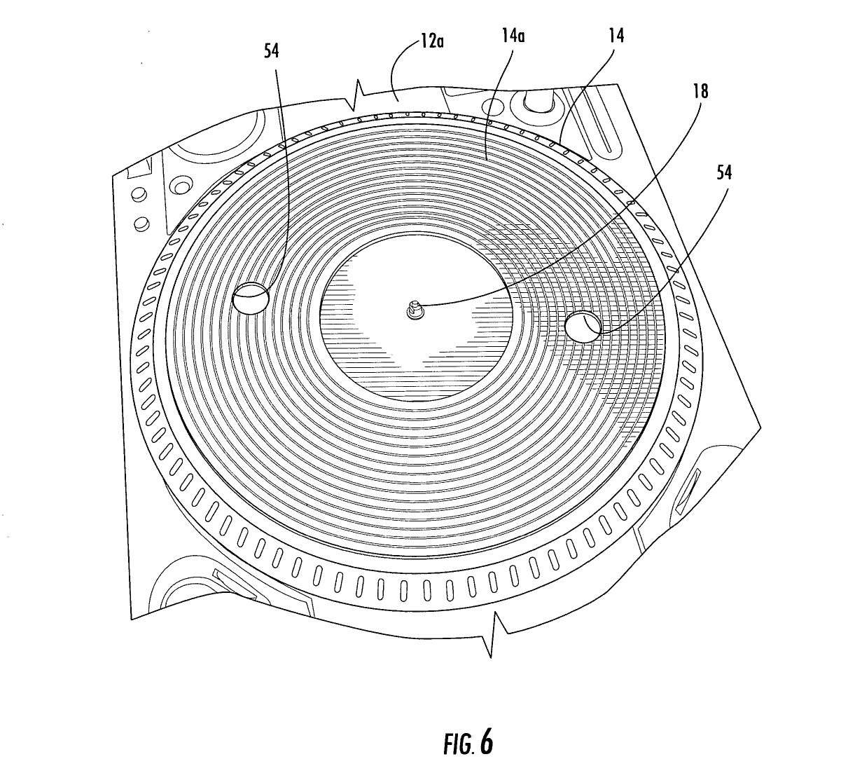

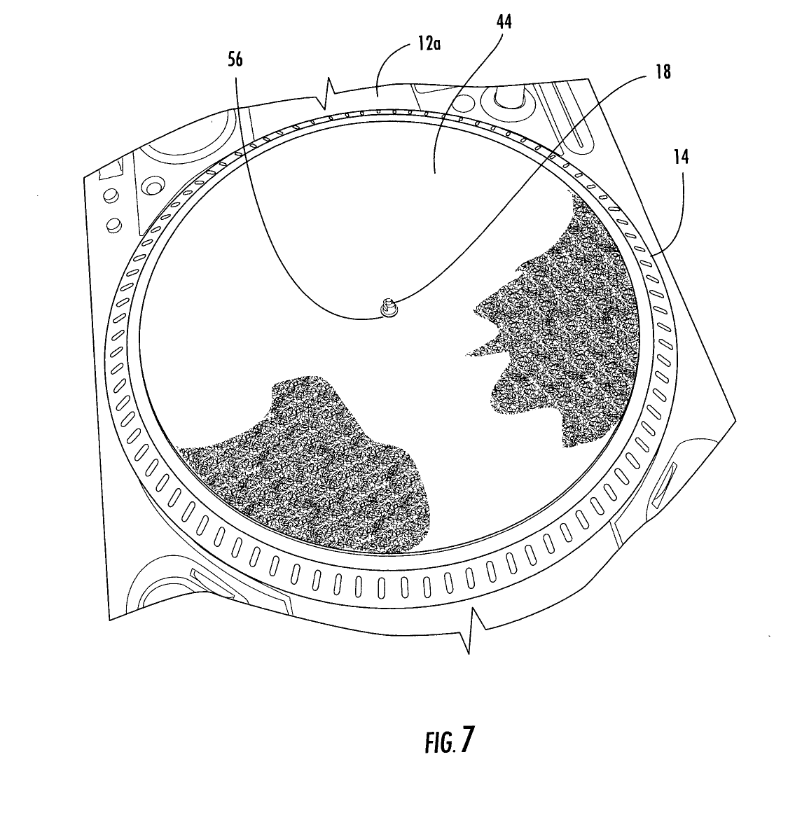

Turning now to FIG. 2, an exploded perspective view of the motor drive assembly, generally referred to as 24, is shown. Further details of the connection of the platter 14 and the circular disc 16, such as the vinyl record, to the drive assembly 24 will be described in detail in connection with FIGS. 3-7.

In FIG. 2, a base plate 26, which is connected to the main housing 12 shown in FIG. 1, is provided with a pass-through aperture 28 for receiving the motor body 32 of a direct drive motor 30 therethrough. The motor 30 includes a motor housing 32 with a annular-shaped magnet 34 affixed to the inner surface thereof. A hollow spindle 36 is affixed to the outer housing 32 of the motor 30. As a result, the motor housing 32 rotates in unison with hollow spindle 36. As shown in FIG. 3, a plurality of wire coils 38, mounted on posts 40, emanate radially outward toward the annular magnet 34 within the motor 30. The coils 38 are preferably wound from of metal wire, such as copper, as is well known in the art. The posts 40 that support the coils 38 are mounted to a support circuit board 42 which is, in turn, mounted to the base plate 26 which is attached to the main housing 12 of the playback device 10. When electricity is passed through the coils 38, the annular magnet 34 and motor housing 32 rotate in unison thereby providing a direct motorized drive for the platter 14. The hollow spindle 36 is preferably made of metal, such as aluminum, or can be other materials, such as plastic.

The center 18 spindle is co-axially mounted through the hollow spindle 36 and freely rotates within the hollow spindle 36. The center spindle 18 is preferably made of metal, such as aluminum, or can be other materials, such as plastic. The activation of the coils 38 only rotates the annular magnet 34 (e.g. metallic) and motor housing 32 connected thereto not the center spindle 18.

The motor 30 is preferably high-torque with a power of 4.5 kgf-cm. The motor 30 can operate at 33 RPM or 45 RPM. A direct drive motor 30 is preferred over other types of motors for its reliability and performance. Also, stationary coils 38 are preferred, however, other types of motors, such as ones with a stationary magnet, are also contemplated by the present invention. These motor configurations are considered to be within the scope of the present invention.

FIG. 2 further generally shows the attachment of the platter 14 to the top surface 32a of the motor housing 32 with a slip mat 44 positioned thereon with a circular disc 16 further residing thereon and connected to the freely rotating center spindle 18. Details of the interconnection of the turntable platter 14 to the motor housing 32 is seen in FIGS. 4 and 5. In FIG. 4, a perspective view is shown of the motor 30 extending upwardly through the aperture 28 in base plate 26. As described above, the motor housing 32 rotates within the aperture 28 in the base plate 26 when electricity is passed through the coils 38 in the motor 30. A number of keying holes 46 are provided on the top 32a surface of the motor housing 32 for engaging with the turntable platter 14, the bottom of which is shown in FIG. 5. The bottom of the platter 14, which is preferably made of aluminum, includes a mounting connection area in the center thereof, generally referred to as 48. The mounting connection area 48 includes a pair of keying posts 50 that engage with and reside in the keying holes 46 on the top surface 32a of the motor housing 32. A number of contact pads 52 are also provide within the mounting connection area 48 to communicate with the flat top surface 32a of the motor housing 32 to ensure that the platter 14 remains level and parallel with the top surface 32a of the motor housing 32. The platter 14 simply rests on the top of the motor housing 32 and is held in place by gravity, as shown in FIG. 3. Finger holes 54 are also provided to facilitate handling of the platter 14.

As a result of the keying engagement of the platter 14 to the motor housing 32, electrical activation of the coils 38 in the motor 30 will effectively rotate the motor housing 32 and the platter 14 simultaneously. Thus, the platter 14 can be rotated to simulate the rotation of a platter of an analog turntable. However, unlike a prior art analog turntable, the center spindle 18 through the center of the platter 14 rotates independently of the platter 14. In a prior art platter, the center spindle is simply an upward projection from the platter and, as a result, rotates with the platter.

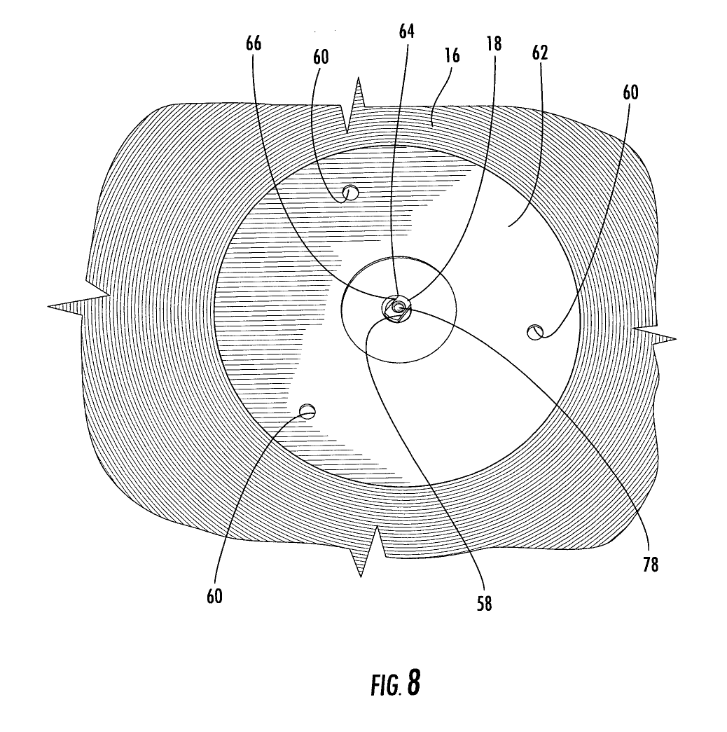

Once installed on the motor 30, the platter 14 is in condition for receipt of a slip mat 44 thereon. As seen in FIG. 7, a standard slip mat 44 is placed over the top surface 14a of the platter 14. Scratch slip mats 44 are commonly made of foam or felt and provide the needed combination of slippage and grip of a record relative to the platter that is essential to proper scratching feel. The slip mat 44 includes a center hole 56 that permits the center spindle 18 to emanate upwardly therethrough.

In accordance with the present invention, the platter 14 and circular disc 16 rotate independently from one another. The platter 14 is connected to the motor 30 which controls the rotation thereof. The rotation of the center spindle 18 is controlled by the user's on-the-fly manipulation in real time. The interface for accomplishing this is a standard sized vinyl record, generally referred to as a circular disc 16, as mentioned above. Thus, there is a need to securely affixed the circular disc 16 to the center spindle 18 to ensure that the center spindle 18 rotates whenever the circular disc 16 is rotated. FIGS. 8-10 illustrated in detail the interconnection of the circular disc 16 to the center spindle 18. It should be understood that the following interconnection is the preferred method of interconnection but other interconnections may be employed and still be within the scope of the present invention.

In FIG. 8, a circular disc, such as a standard vinyl record is employed. The circular disc 16 includes the standard center hole 58 found in all LP discs. A number of keying structures, such as through-holes 60, are preferably provided through the label portion 62 of the circular disc 16. An array of three holes 62 are preferably provided, however, other arrays can be used. For example a single hole 62 may be used. Also, the keying structures can be indents in the surface of the circular disc 16 or projections upwardly from the disc 16.

The free end 64 of the center spindle 18 also has a keyed structure. Preferably, the free end 64 of the center spindle 18 is of a double cutaways 66 to result in an transversely elongated tip. However, other structures can be used to key the free end 64 of the center spindle 18.

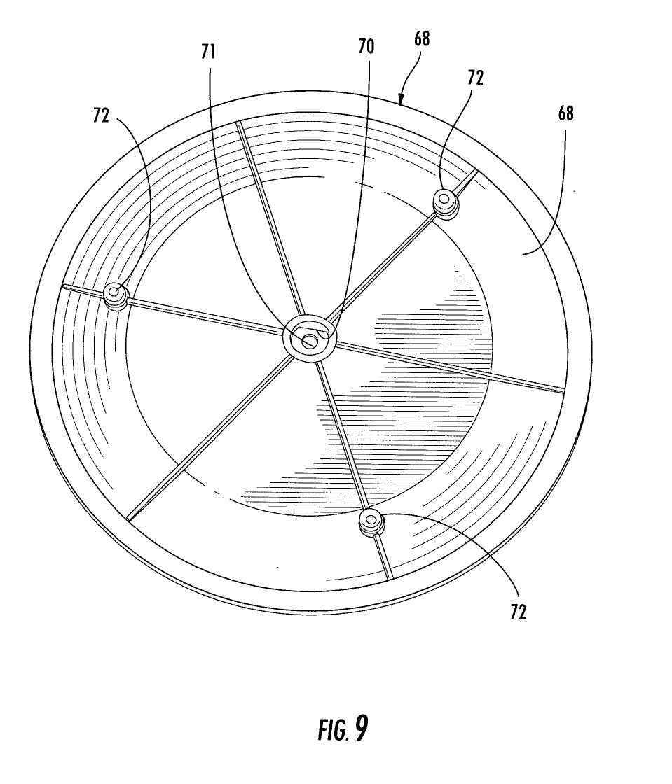

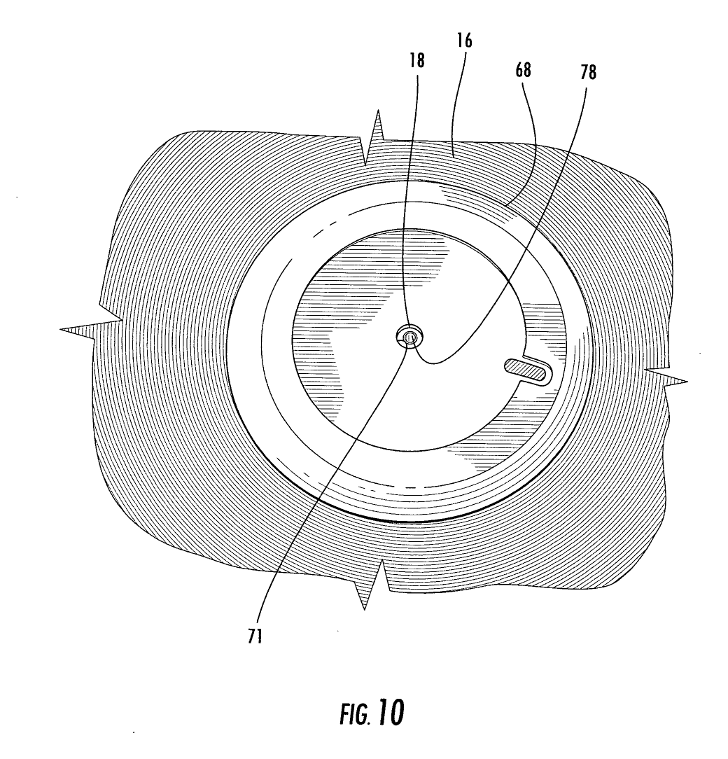

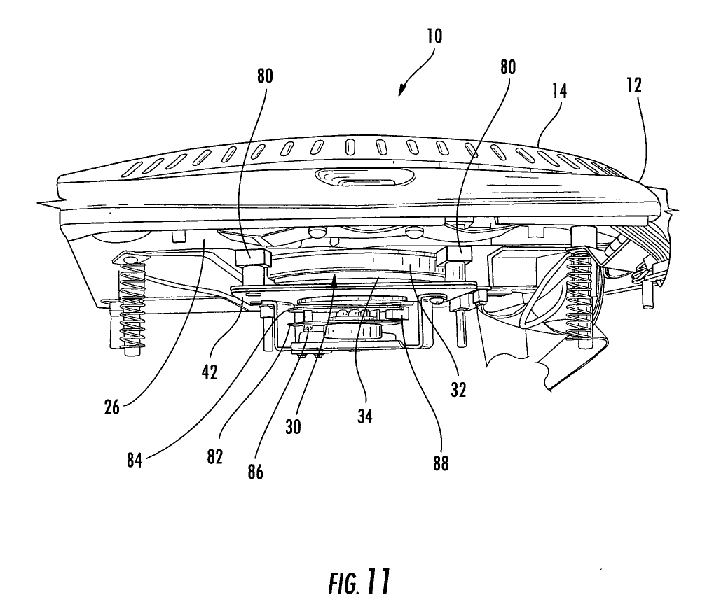

A locking cap 68, a bottom view thereof shown in FIG. 9, is employed to secure the circular disc 16 to the center spindle 18. The locking cap 68, preferably made of plastic, includes on its bottom side 68a a keyed seat 70 for receiving the spindle 18, namely, its keyed free end 64. A pass-through hole 71 is also provided. The keyed seat 70 engages with the free end 64 of the center spindle 18 in complementary fashion. For further keying, an array of three posts 72 are provided on the bottom side 68a of the locking cap 68 to respective engage and reside in the three holes 60 through the label portion 62 of the circular disc 16. The array of through holes 60 and mating posts 72 are preferably offset from one another rather than precisely 120 degrees apart and/or the same distance from the center hole 58 of the circular disc 16 to facilitate the orientation and centering of the locking cap 68 on the holes 60 and free end 64 of the center spindle 18 in seat 70. A top view of the mating of the locking cap 68 onto the circular disc 16 is shown in FIG. 10. Indicia 74 further assists in alignment of the locking cap 68.

To secure the locking cap 68 to the center spindle 18 with the circular disc 16 sandwiched therebetween, a threaded fastener 76, as seen in FIG. 2, is secured to the free end 64 of the center spindle 18 via the through-hole 71 in the locking cap 68. More specifically, the threaded fastener includes a made body 76a and a male threaded base 76b. The free end 64 of the center spindle 18 includes a female threaded bore 78 to receive the male threaded base 76b of the threaded fastener 76. The threaded fastener 76 is preferably reverse threaded, i.e. left hand threaded, to prevent unscrewing during use of the playback device 10, namely, rotation of the platter 14. A washer 80 is also preferably employed to ensure a tight threaded engagement of the threaded fastener 76 and the center spindle 18 and to prevent unscrewing during use of the playback device 10.

Further, the threaded fastener 76 is preferably configured to be in the shape of the tip of a spindle of an analog turntable to even further simulate the appearance of the playback device 10 of the present invention as an analog turntable. Thus, the pointed free end 76c of the threaded fastener 76 is aesthetic in nature only.

Thus, the platter 14 is securely attached to the motor housing 32 and the circular disc 16 is securely attached to the center spindle 18. The speed and direction of the rotation of the platter 14 and the circular disc 16 must be independent measured so that the audio signal can be modified in accordance therewith.

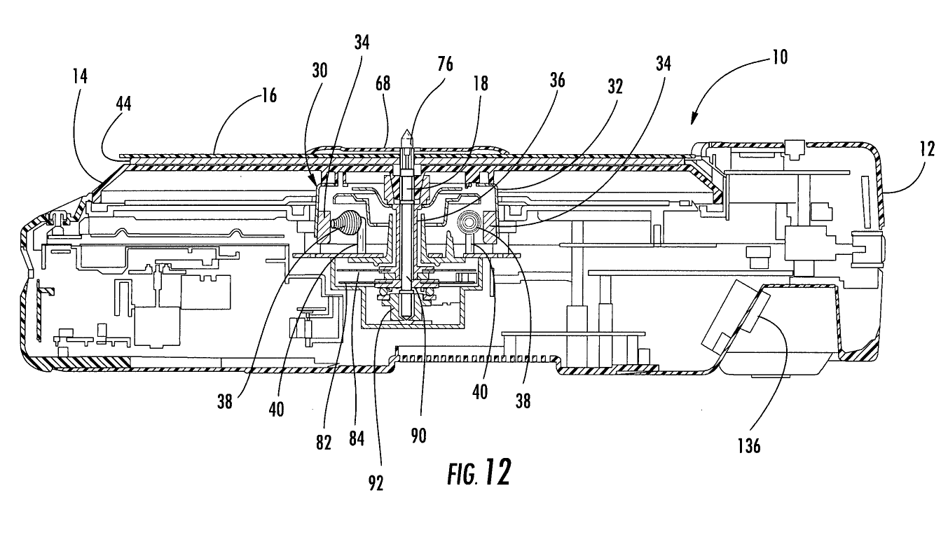

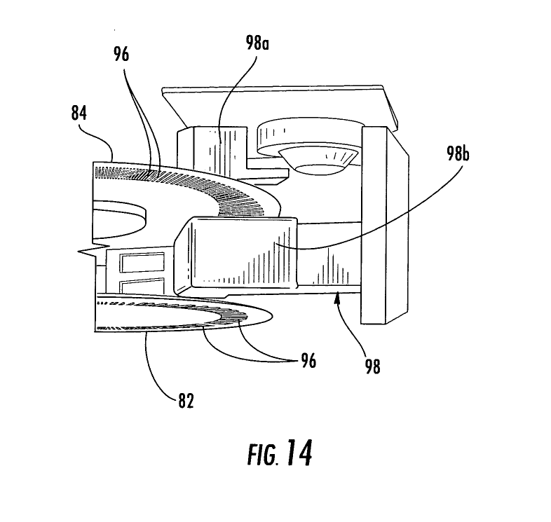

Referring now to FIGS. 11-15, details of the rotation speed and direction of the circular disc 16 and platter 14 are shown. In FIG. 11, a side elevational view of the playback device 10 of the present invention is shown with the lower portion of the outer housing 12 removed for ease of discussion. The platter 14 rotates above the upper portion of the main housing 12. A number of mounting blocks 80 are connected to the base plate 26 through which the motor 30 is mounted. FIG. 3 illustrates the motor 30 prior to mounting. Referring to both FIGS. 3 and 11, the circuit board 42 is affixed to the mounting blocks 80 onto which the coils 38 are attached, as seen in FIG. 3. As generally shown in FIGS. 3 and 11, a first encoding disc 82 is provided for the center spindle 18 and circular disc 16 connected thereto and a second encoding disc 84 is provided for the hollow spindle 36 and the platter 14 connected thereto. Optical detectors 86, 88 are respectively provided for each of the encoding discs 82, 84. Details of the preferred structure of the encoding discs 82, 84 are discussed below in connection with FIGS. 13-15.

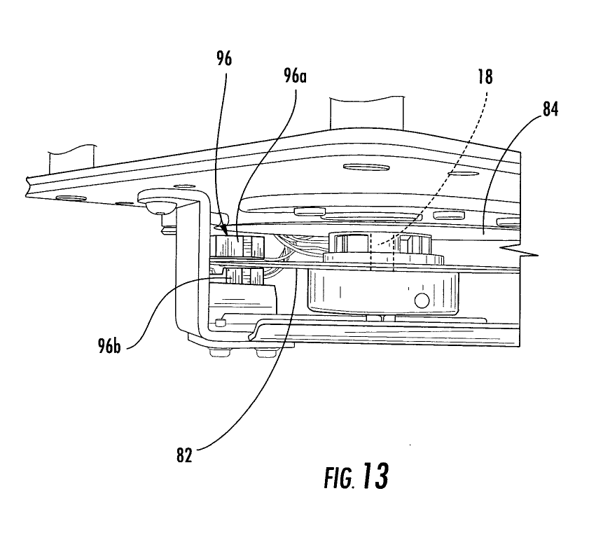

Referring now to FIG. 12, a cross-sectional view through the line 12-12 of FIG. 1 is shown to illustrate the preferred arrangement of components of the present invention. The circular disc 16 is coupled to the center spindle 18 with the assistance of the locking cap 69 attached to the top free end 64 of the center spindle 18. The bottom free end 90 of the center spindle 18 terminates with a first (lower) encoder disc 82 that is attached thereto by a connector assembly generally referred to as 92. Thus, when the circular disc 16 rotates due to user manipulation, the center spindle 18 will, in turn rotate, thereby rotating the lower encoder disc 82.

The center spindle 18 is routed through the hollow spindle 36 which is connected to the platter 14 via the motor housing 32. When the coils 38 are electrically activated, the annular magnet 34 and motor housing 32 rotate thereby rotating the hollow spindle 36. Attached to the hollow spindle is a second (upper) encoder disc. When the hollow spindle 36 rotates, the upper encoder disc 84 rotates as well. The use of a hollow outer spindle 36 and an inner center spindle 18 routed therethrough is preferred but is one of many different types of spindle arrangements that can be employed in accordance with the present invention.

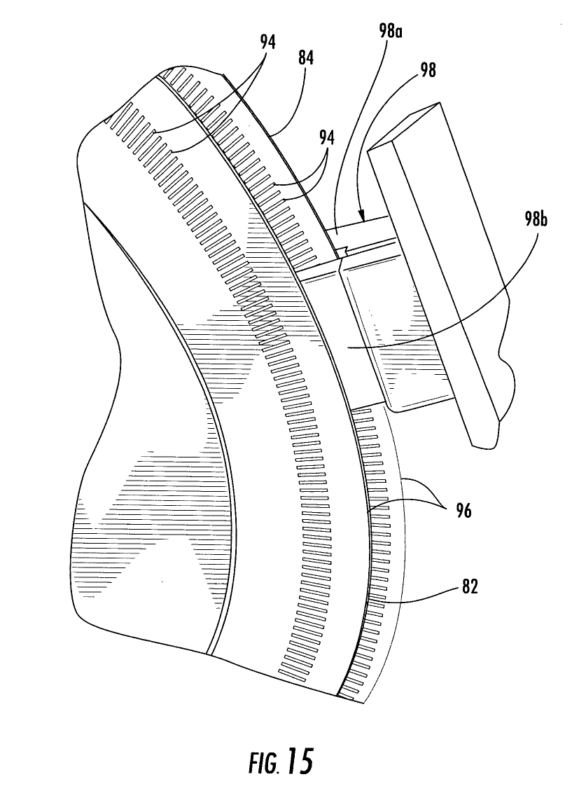

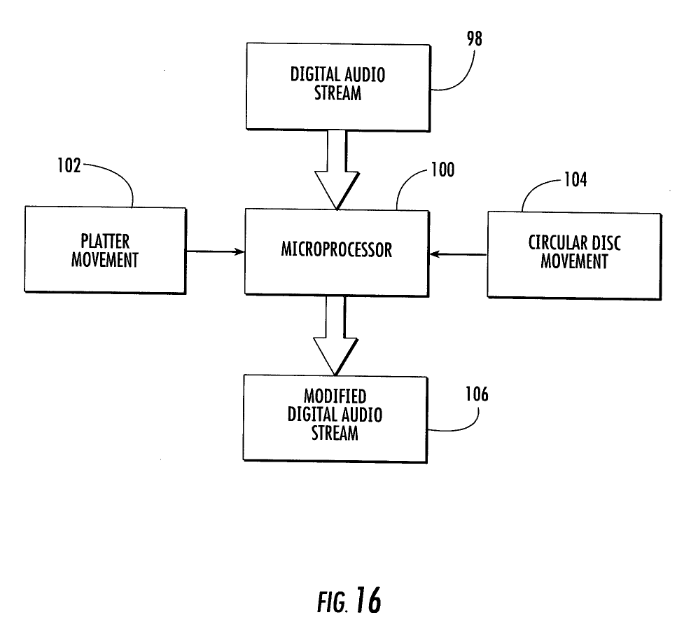

FIG. 13 shows a close up elevational view of the lower encoder disc 82 that is connected to the center spindle 18 while FIG. 14 shows a close up elevational view of the upper encoder disc 84 that is connected to the hollow spindle 36 (not seen in FIG. 14). FIG. 15 is a bottom perspective view of the encoder discs 82, 84 to illustrate their configuration. More specifically, an array of slits 94 are preferably provided at the free edges 96 of the encoder discs 82, 84. A pair of optical sensors 96, 98 respectively embrace the outer free edges of the lower encoder disc 82 and upper encoder disc 84. The optical sensors 96, 98 each include a optical emitter 96a, 98a one side and an optical detector 96b, 98b on the other side. The positioning of the emitters 96a, 98a relative to the detectors 96b, 98b may be reversed, if desired. Light is directed through the slits 96 and is detected on the opposing side of the respective disc 82, 84 by the respective optical sensor 96, 98. The pattern of detected light sensed by the optical detector 96b, and can be easily used to determine the speed and direction of the circular disc 16 and the spindle 18 connected thereto. For example, the leading and trailing edges of the slits 96 can be sensed for the purposes of determining direction and speed of the rotation of an encoder disc 82, 84. As seen in FIG. 16, an audio stream 98 is routed to a microprocessor 100 as modified in real time by data representing the platter movement 102 and circular disc movement 104 to generate a modified digital audio output stream 106. The modified stream can be outputted directly to a digital output port (not shown) from the playback device 10 or through an analog output port via digital to analog converters. The sensed values are processed in real time to determine the rotational direction and speed of the center spindle 18 and hollow spindle 36 thereby measuring the rotational speed and direction of the circular disc 16 and platter 14, respectively. The relative speeds and directions of the platter 14 and the circular disc 16 are processed to modify the audio signal 98 in real time to provide a modified signal 106.

Use of digital encoding discs using optical sensors for the determination of speed and direction of rotation are well known in the art and need not be discussed in further detail herein. The encoder discs 82, 84 are preferably made of stamped or perforated metal, such as steel or aluminum but could be made of other materials.

In that connection, there are many different methods for measuring the speed and direction of rotation of the hollow spindle 36 and center spindle 18. The preferred technique is to employ the encoder discs 82, 84 with slits 96 and optical sensors 96, 98 for their accuracy and low cost. However, it should be understood that many other techniques for detecting the rotation speed and direction of the spindles 18, 36 are contemplated herein and are within the scope of the present invention.

For operation of the present invention, the playback device 10 is powered up and a compact disc 22 is inserted into the slot 20 in the front of the device 10 and is effectively loaded into the compact disc optical reader 19. An audio track is selected using the selector knob 108 and display 110 for playback from the optical disc 22. Alternatively, as discussed above, the playback device 10 of the present invention may include a hard drive or memory disc from which the audio file may be retrieved. Once the audio file is loaded from the appropriate storage source, two PLAY buttons 112 are provided for right and left handed use. Either button 112 can be depressed to start playback of the audio track. At this point, the platter 14 will simultaneously begin to rotate to simulate playback on an analog turntable. Thus, the rotation of the platter 14 indicates that playback is in progress. In this condition, the platter 14 is being driven by the motor 30.

During this normal playback, the circular disc 16 is in frictional communication with the platter 14 via the slip mat 44. There is enough friction therebetween that the circular disc 16 rotates in synchronization with the platter 14. The speeds and direction of both the circular disc 16 (i.e. vinyl record) and the platter 14 will be detected by their respective optical encoders 82, 84 and sensors 96, 98 as being equal. Thus, the microprocessor 100 simply plays back the audio signal without modification as outputted by the optical reader 19. The playback signal is based on speed and direction of both the circular 16 disk and platter 14.

For playback of a modified audio signal, such as scratch playing, the speed and/or direction of one or both of the platter 14 and the circular disc 16 are altered by the user of the playback device 10. For example, both the platter 14 and the circular disc 16 can be slowed down the same amount. The microprocessor 100 uses the information to output the appropriate slowed down audio. In another example, if the platter 14 is moving forward at normal speed and the circular disc 16 is moving reverse at normal speed, then the outputted audio 106 will be the audio signal played in reverse. For scratching, it is possible that the platter 14 is moving forward while the circular disc 16 is being moved back and forth. Scratching, pitch bending and cueing can be easily carried out with the present invention.

Thus, the optical detectors 82, 84 will sense all of the relative movements of the circular disc 16 and the platter 14 to deliver real time signals to the microprocessor 100 to play the audio signal forward and backward according to the actions sensed. This processing can be carried out by software that is in read only memory (ROM), onboard a chip or loaded via removable storage.

It should be noted that real time microprocessor control of a audio signal based on the input of some type of user controller is well known in the art. Therefore, further details thereof need not be addressed herein.

The playback device 10 of the present invention includes many operational features to take advantage of the realistic record control of an audio signal. Referring back to FIG. 1, the power switch (not shown) is engaged to deliver power to the device 10. A compact disc 22, that contains the audio file to be manipulated, is inserted into CD ROM drive 19 via the front-loading slot. The eject button 24 ejects the compact disc 22 from the CD ROM drive 19. The TRACK/MENU SELECT knob 108 is rotated to select tracks. Depressing it selects is for playback. The PLAY/PAUSE 112 buttons starts and stops playback and the platter 14. Pressing buttons 112 toggles between PLAY and PAUSE of the platter. Each time a PLAY button 112 is pressed after PAUSE, a new cue point is set. A brake adjust wheel 114 is also provided to change the amount of time it takes to stop the platter 14. A startup adjust wheel 116 is also provided. A CUE button 118 returns and pauses the audio at the last set cue point. A STUTTER button 120 starts the audio from either the first set cue point or the last point of pause.

Various other operations can be carried out by the device. For example, a scratch mode button 122 and a pitch button 124 are provided to further change how the audio reacts to manipulation of the circular disc. A PITCH slider 126 enables the speed of the platter to be custom set from a standard 33 RPM or 45 RPM. A JOG wheel 128 is used to set effects and control pitch. A beat tracker 130 is preferably built into the playback device 10 to further enhance the use thereof. Looping buttons 132 are employed to control the formation and playback of looped portions of audio. For example, a start point and a stop point can be easily set and used with or without beat tracking to play the selected loop in synchronization with the beat. Various effect buttons 134 can be used to further alter the output of the audio changing its sound characteristics and profile.

The playback device 10 of the present invention can be easily connected to other audio and video equipment by an audio/video set of connectors, generally shown as 136 in FIG. 12, on the back of the device. In general, RCA-type connectors for left and right channel are preferably provided as well as a digital output. A relay connector and a remote start connector can also be provided. Input and output ports for Music Instrument Digital Interface (MIDI) are provided for digital interconnection to other MIDI devices. A voltage selector and power plug connector are also preferably provided. Such connectors are well known in the art and are familiar to disc jockeys and audio technicians.

It would be appreciated by those skilled in the art that various changes and modifications can be made to the illustrated embodiments without departing from the spirit of the present invention. All such modifications and changes are intended to be covered by the appended claims.

1. A sound playback device controllable by a user, comprising:
a motor;
a hollow spindle, having a rotational axis, connected to and driven by the motor;
a platter connected to the hollow spindle; the platter having a rotational speed and direction;
a center spindle, having a rotational axis and a top free end, routed through the hollow spindle; the rotational axis of the hollow spindle being co-axial with the rotational axis of the center spindle; the center spindle having a rotational speed and direction;
a user manipulateable member connected to the center spindle; the user manipulateable member having a rotational speed and direction and a top side and a bottom side; the bottom side facing the platter;
means for detecting the rotational speed and direction of the platter to create a platter control signal;
means for detecting the rotational speed and direction of the user manipulateable member to create a user manipulateable member control signal;
a digitized audio signal;
processing means for modifying the digitized audio depending on the platter control signal and the user manipulateable member control signal to create an output signal.

2. The device of claim 1, wherein the motor is a direct drive motor.

3. The device of claim 2, wherein the hollow spindle and the center spindle are routed through the direct drive motor.

4. The device of claim 1, wherein the user manipulateable member is a circular disc having a center spindle hole.

5. The device of claim 4, wherein the circular disc is a vinyl record.

6. The device of claim 4, wherein the circular disc is removably connected to the center spindle.

7. The device of claim 1, wherein the user manipulateable member is in frictional communication with the platter.

8. The device of claim 1, further comprising a slip mat disposed between the user manipulateable member and the platter.

9. The device of claim 1, wherein means for detecting the rotational speed and direction of the platter to create a platter control signal further comprises:
a first digitally encoded disc connected to the hollow spindle; and
a first optical sensor positioned proximal to the first digitally encoded disc.

10. The device of claim 1, wherein means for detecting the rotational speed and direction of the user manipulateable member to create a user manipulateable member control signal further comprises:
a second digitally encoded disc connected to the center spindle; and
a second optical sensor positioned proximal to the second digitally encoded disc.

11. The device of claim 4, further comprising:
means for removably coupling the circular disc to the center spindle.

12. The device of claim 11, wherein the means for removably coupling further comprises:
a rotational key provided on the top free end of the center spindle; the center spindle being routable through the center spindle hole of the circular disc; the circular disc defining at least one keying member;
a locking cap having a top side and a bottom side with a rotational key engaging member and an at least one keying member engaging member on the bottom side thereof; the locking cap removably securing the circular disc to the center spindle whereby rotation of the circular disc rotates the center spindle.

13. The device of claim 11 wherein the at least one keying member is at least one hole through the circular disc.

14. The device of claim 13, wherein the at least one keying member engaging member is at least one post emanating from the bottom side of the locking cap that is engageable with the at least one hole through the circular disc.

15. The device of claim 11 wherein the at least one keying member is three holes through the circular disc.

16. The device of claim 15, wherein the at least one keying member engaging member is three posts emanating from the bottom side of the locking cap that are engageable with the three holes through the circular disc.

17. The device of claim 1, wherein the output signal is modifiable in real time to create a scratch effect of the digitized audio signal.

18. The device of claim 1, wherein the output signal is slowed down compared to the digitized audio signal.

19. The device of claim 1, wherein the output signal is sped up compared to the digitized audio signal.

20. The device of claim 1, wherein the processing means includes a microprocessor and software.

21. A dual co-axial digital rotational encoder, comprising:
a hollow spindle, having a rotational axis; the hollow spindle having a rotational speed and direction;
a center spindle, having a rotational axis and a top free end, routed through the hollow spindle; the rotational axis of the hollow spindle being co-axial with the rotational axis of the center spindle; the center spindle having a rotational speed and direction;
means for detecting the rotational speed and direction of the first rotating member to create a first control signal; and
means for detecting the rotational speed and direction of the second rotating member to create a second control signal.

22. The encoder of claim 21, further comprising:
a first rotating member connected to the hollow spindle.

23. The encoder of claim 21, further comprising:
a second rotating member connected to the center spindle.

24. The encoder of claim 21, further comprising:
means for processing the first control signal and the second control signal to create a main control signal for modification of a audio signal.
